(19) United States
(12) Patent Application Publication
(10) Pub. No.: US 2001/0025843 A1
(43) Pub. Date: Oct. 4, 2001

(54) Cooking appliances

(76) Inventor: John William McClean, Roselands (AU)

Correspondence Address: ROGER T. FROST, KILPATRICK STOCKTON LLP, 2400 Monarch Tower, 3424 Peachtree Road, N.E., Atlanta, GA, 30326, US

(21) Appl. No.: 09/778,476

(22) Filed: Feb. 7, 2001

(30) Foreign Application Priority Data
Feb. 8, 2000 (AU) PQ5491/00

(51) Int. Cl. A47J 27/02; H05B 3/68

(52) U.S. Cl. 219/432; 219/450.1; 219/455.11; 219/465.1; 219/433; 219/436

(57) ABSTRACT

A cooking appliance having a bowl portion and a hotplate portion whereby differing cooking modes can be simultaneously effected by the appliance.

### TECHNICAL FIELD

The present invention relates to cooking appliances and more particularly a portable appliance adapted to two distinctly difference cooking modes in the one appliance at the same time

### BACKGROUND ART

Portable cooking appliances such as frying pans, deep fat fryers, electrically powered woks, electric grills and frying pans are well known and extensively marketed to consumer households. By having a large number of separate cooking appliances, dependant upon the mode of cooking involved, there is a considerable cost and storage space burden imposed on consumers.

### SUMMARY OF THE INVENTION

It is an aim of the present invention to provide a single portable cooking appliance having the capability of providing the cooking modes mentioned above for the range of separate specialized cooking appliances.

Throughout this specification and the claims which follow, unless the context requires otherwise, the word “comprise”, or variations such as “comprises” or “comprising”, will be understood to imply the inclusion of a stated integer or step or group of integers or steps but not the exclusion of any other integer or step or group of integers or steps.

The present invention provides a cooking appliance having a recessed bowl portion with a hotplate projecting substantially horizontally from the rim of the bowl portion in a plane containing the rim of the bowl portion. Preferably, the hotplate portion is elongate in the direction of a diameter of the mouth of the bowl portion, but of a width slightly larger than said diameter.

In a particularly preferred embodiment, a single heating element is fitted to the appliance to heat the hotplate and the bowl portion, thereby avoiding the complexity and expense of separate heating elements and heating controls for controlling the temperature of the hotplate and the bowl portions.

An embodiment of a cooking appliance of the present invention can employ the bowl portion as a deep fat fryer or wok or saucepan. The addition of a covering lid that covers the entire cooking surfaces of the appliance or selectively covers the bowl portion or hotplate can be provided. A cover or lid for the entire appliance enables the appliance to be used as a benchtop oven.

An embodiment of a cooking appliance of the present invention employs a single continuous heating element affixed to the undersurface of the hotplate. The heating element traverses beneath the hotplate then follows a path downwardly and around the mid to lower regions of the bowl portion before again traversing the underside of the hot plate to end in a probe coupling at the perimeter of the hotplate.

In another embodiment, the path for the electric heating element around the bowl portion may be of the form disclosed and claimed in our Australian Patent 704420.

### BRIEF DESCRIPTION OF THE DRAWINGS

The present invention will now be described by way of example with reference to the accompanying drawings, in which:

FIG. 1 is an exploded view of one embodiment of a cooking appliance in accordance with the present invention;

FIG. 2 is a longitudinal cross-sectional view of the appliance of FIG. 1 in its assembled condition;

FIG. 3 is a plan view of the appliance of FIG. 1 with the lid removed;

FIG. 4 is the section view for IV-IV of FIG. 3;

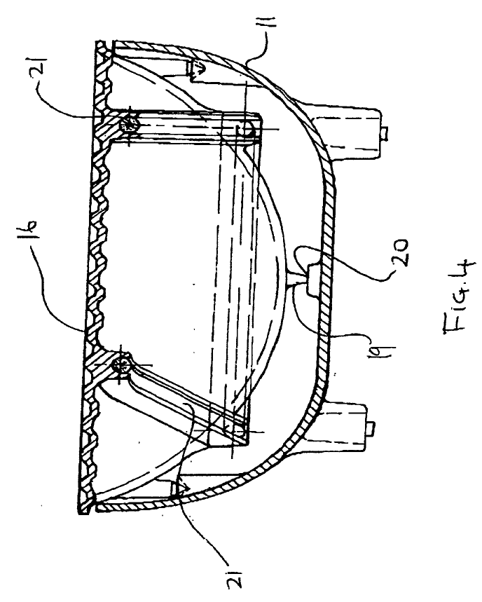

FIG. 5 is the section view for V-V of FIG. 3;

FIG. 6 is an underside perspective view of the appliance of FIG. 1 excluding the lid; and

FIG. 7 is a view similar to FIG. 1 but showing a lid which covers only part of the total cooking surfaces of the appliance.

### EMBODIMENTS

The cooking appliance 10 as shown in the drawings comprises a base member 11 in which is mounted a drip tray/bowl 12.

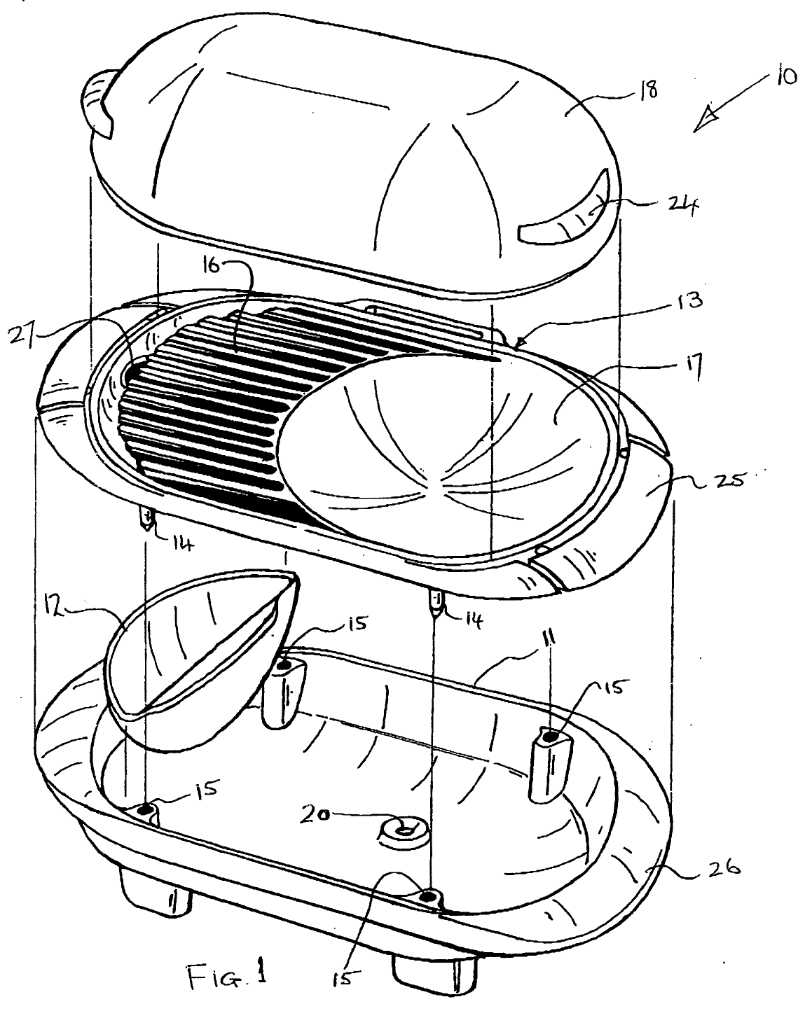

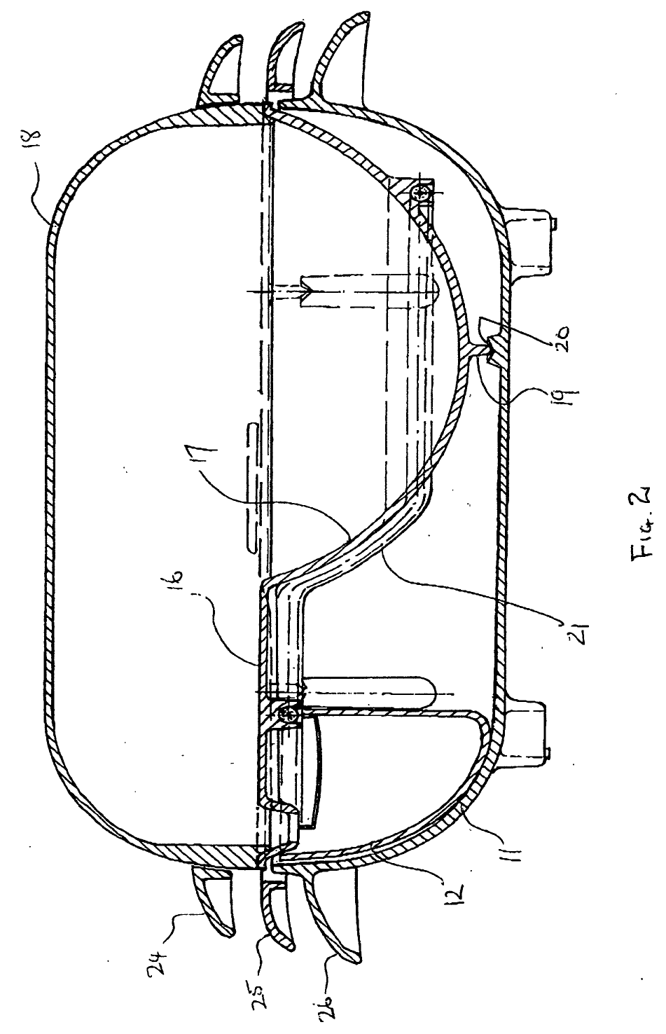

Cooking surfaces 13 rest on base 11 via locating pins 14 which fit within corresponding bores 15 in base 11 Cooking surfaces 13 comprise a grilling plate 16 and a bowl portion 17. In the embodiment of FIGS. 1 and 2, lid 18 is shown as being adapted to cover cooking surfaces 16 and 17.

As can be seen in FIG. 2, a locating lug 19 underneath bowl portion 17 is adapted to fit within recess 20 in base 11 as a locater and additional support to bowl 17 when mounted in base 11.

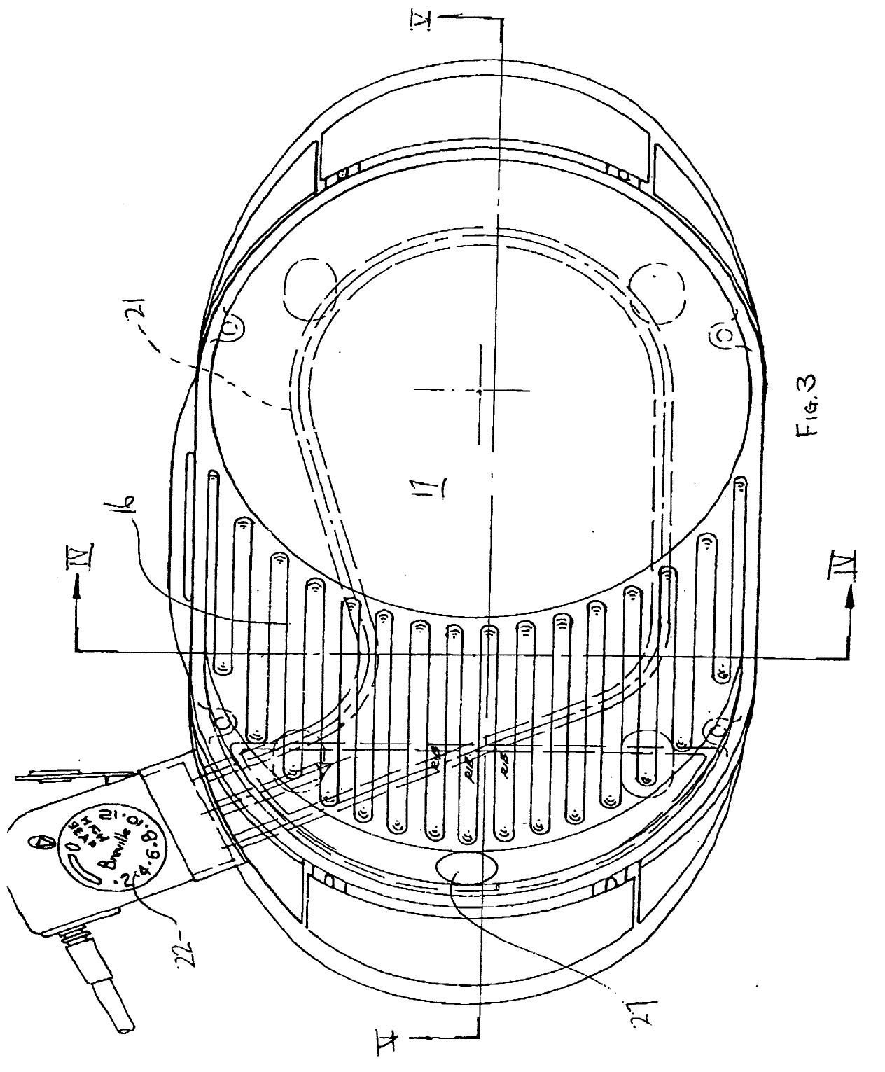

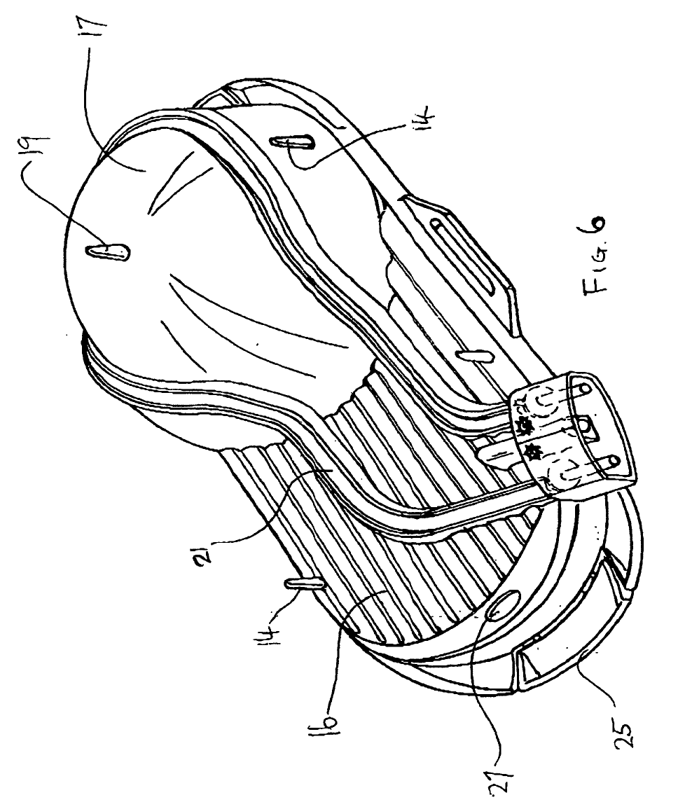

A single heating element 21 is provided in this embodiment which follows the pathway shown on the underside of cooking surfaces 16 and 1.7 as clearly shown by FIGS. 2, 3 and 6. The heating rate of element 21 is controlled by adjustable switch unit 22 in combination with probe 23 in a manner well understood for electrically operated cooking appliances.

Each of the lid cooking surfaces and base include respective handles 24, 25 and 26 which allow each of those parts to be independently manually transported even when heated by operation of element 21.

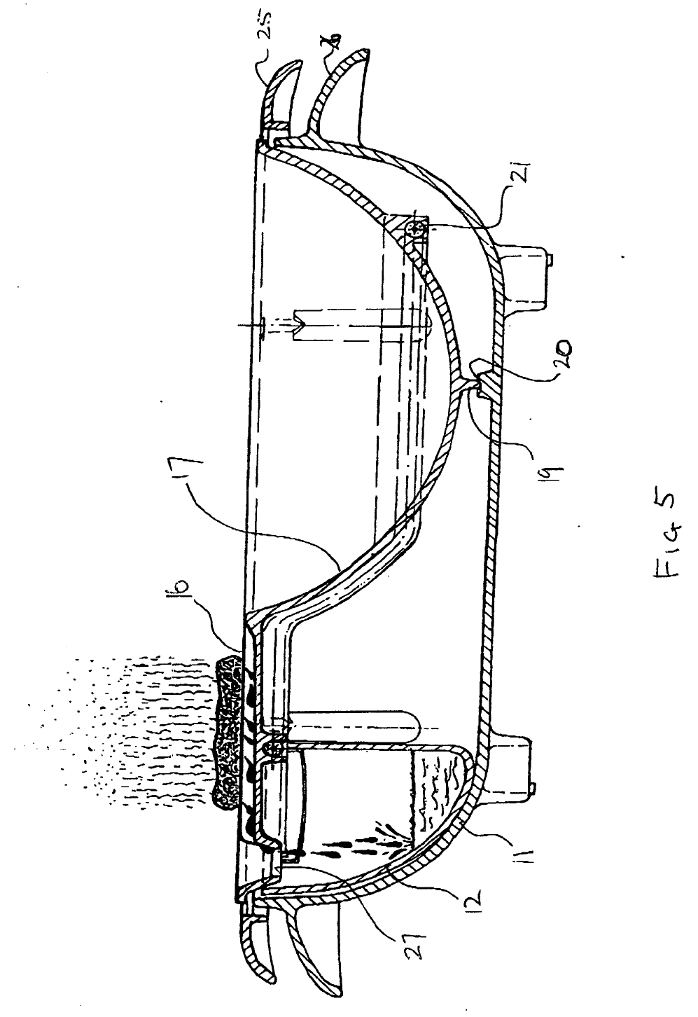

FIG. 5 shows that hotplate 16 is formed with elongate ribs where the valleys between each rib slope away from bowl portion 17 to direct the flow of fats and other liquid toward receptacle 12 situated beneath orifice 27.

As will now be readily appreciated by the addressee the appliance of this embodiment can be used for simultaneously deep fat frying food products in bowl 17 while broiling meats and other food products on hotplate 16. In an alternative use bowl 17 can function as a wok for stir-frying vegetables while hotplate 16 is used to broil meats or seafood or the like. In a still further arrangement the appliance can be employed as an oven once lid 18 is in place so that differing food products can be cooked within bowl 17 and on hotplate 16.

In another use bowl portion 17 could be employed to boil rice while hotplate 16 is broiling a different food product. A still further mode envisages using the bowl 17 to cook pasta while hotplate 16 cooks another accompaniment or even different meal. It is envisaged that an embodiment of an appliance of this invention could be used to cook two differing meals at the same time as between use of bowl 17 and hotplate 16.

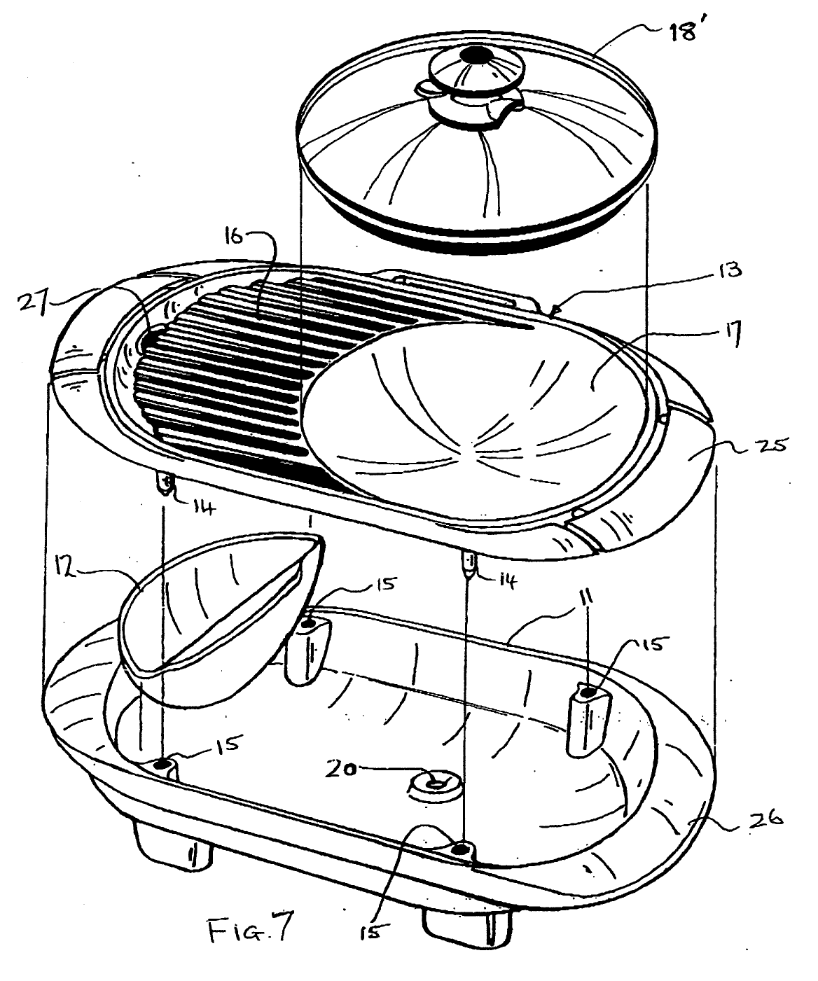

The embodiment of FIG. 7 is identical to that of FIGS. 1 and 2 except that lid 18 has been replaced by lid 18′. Lid 18′ is sized to cover bowl portion 17 only rather than bowl 17 and hotplate 16.

It will be understood by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

It will be appreciated by persons skilled in the art that numerous variations and/or modifications may be made to the various aspects of the present invention as shown in these specific embodiments without departing from the spirit or scope of the invention as broadly described. The present embodiments are, therefore, to be considered in all respects as illustrative and not restrictive.

1. A cooking appliance having a recessed bowl portion with a hotplate projecting substantially horizontally from the rim of the bowl portion in a plane containing the rim of the bowl portion.

2. A cooking appliance as claimed in claim 1 wherein the hotplate portion is elongated in the direction of a diameter of the mouth of the bowl portion.

3. A cooking appliance as claimed in claim 2 wherein the width of the hotplate portion is slightly larger than the diameter of the mouth of the bowl portion.

4. A cooking appliance as claimed in any one the preceding claims wherein the bowl and hotplate portions are heated via a common electrically powered heating element.

5. A cooking appliance as claimed in any one of the preceding claims wherein the hotplate and bowl portions are separable from a base member for supporting the hotplate and bowl portions when in use.

6. A cooking appliance as claimed in any one of the preceding claims having a cover or lid which covers both hotplate and bowl portions.

7. A cooking appliance as claimed in any one of the preceding claims having a cover or lid adapted to cover only the bowl portion.

8. A cooking appliance substantially as hereinbefore described with reference to the accompanying drawings.
